(19) United States
(12) Patent Application Publication
(10) Pub. No.: US 2019/0084048 A1
(43) Pub. Date: Mar. 21, 2019

(54) TITANIUM-TANTALUM POWDERS FOR ADDITIVE MANUFACTURING

(71) Applicant: Tosoh SMD, Inc., Grove City, OH (US)

(72) Inventors: Eugene Y. Ivanov, Grove City, OH (US); Eduardo del Rio, Dublin, OH (US)

(21) Appl. No.: 16/106,656

(22) Filed: Aug. 21, 2018

Related U.S. Application Data
(60) Provisional application No. 62/559,798, filed on Sep. 18, 2017.

(51) Int. Cl. B22F 9/08; B22F 1/00; B33Y 70/00

(52) U.S. Cl. CPC B22F 9/082; B22F 1/0048; B22F 3/15; B22F 2009/0848; B33Y 70/00

(57) ABSTRACT

A method of making an atomized spherical β-Ti/Ta alloy powder for additive manufacturing, having the steps of: a) blending elemental Ti and Ta powders to form a Ti—Ta powder composition; b) hot-isostatically pressing said powder composition to form an Ti—Ta electrode; and c) processing said Ti—Ta electrode by electrode induction melting gas atomization (EIGA) to produce an atomized spherical Ti—Ta alloy powder. A true spherical Ti-50 wt % Ta alloy powder, the product obtained by the process having the steps of: (a) blending elemental Ti and Ta powders to form a 50 wt %-50 wt % Ti—Ta powder composition; b) hot-isostatically pressing said powder composition to form a Ti—Ta electrode; and c) processing said Ti—Ta electrode by electrode induction melting gas atomization (EIGA) to produce an atomized spherical Ti-50 wt % Ta powder comprising spherical β-Ti/Ta alloy particles.

### CROSS-REFERENCE TO RELATED APPLICATION

This application claims the priority of U.S. Provisional Patent Application Ser. No. 62/559,798 filed Sep. 18, 2017 and is incorporated herein by reference.

### FIELD OF INVENTION

The present invention relates to a spherical Ti—X (where X is refractory metal Ta, Nb, Zr, Hf, Mo, or W) alloy powder obtained by electrode induction melting gas atomization (EIGA) and to methods of making same. This invention yields a spherical Ti-50% wt-Ta alloy powder, with microstructure and properties suitable for use in additive or 3D manufacturing process.

### BACKGROUND

Titanium (Ti) and its alloys are used for bone tissue replacements, such as artificial hip joints, bone plates and screws for fracture fixation due to its biocompatibility, strength and corrosion resistance. However, commonly used implant alloy, Ti-6Al-4V ELI, was originally designed for use as general structural material, particularly in aerospace applications and its mechanical properties, in particular the elastic modulus, are quite higher than that of the bone. Implants of these materials support most of the stress rather than transferring it to the surrounding bone, thereby causing problems around the implant and preventing bone from complete regenerating. In addition, Al and V are toxic elements and may be associated with long-term health problems such as Alzheimer's and neuropathy.

It has been known that β-Ti alloys show low modulus and high strength. Among the Ti β-stabilizing elements, Zr, Nb, Ta, Mo do not cause inflammations and harmful effects to the body. The development of new Ti alloys with these elements has been a subject of significant research in more than a decade, resulting in β-type alloys with moduli between 55 to 85 GPa. Tantalum (Ta) has been considered a biocompatible metal with good potential as biomaterial, with excellent corrosion resistance and good mechanical properties. However, the major drawback is its high density and high melting temperature.

With rapid development of additive manufacturing of patient specific implants, what is needed is a method of production for β-Ti alloy spherical powders that are suitable for additive manufacturing. In many cases, manufacturing of high melting point Ti based alloys are very difficult and new methods of manufacturing are required. This patent application addresses this issue.

### SUMMARY OF INVENTION

In one exemplary embodiment, a method of making an atomized spherical β-Ti/Ta alloy powder for additive manufacturing is disclosed. The atomized spherical β-Ti/Ta alloy powder provides uniformity during melting and processing, as well as uniform particle size distribution and composition.

The method comprises the steps of: a) blending elemental Ti and Ta powders to form a Ti—Ta powder composition; b) hot-isostatically pressing the powder composition to form a Ti—Ta electrode; and c) processing the Ti—Ta electrode by electrode induction melting gas atomization (EIGA) to produce an atomized spherical Ti—Ta alloy powder.

In some embodiments, the elemental Ti and Ta powders are blended to a 50 wt %-50 wt % composition. In other embodiments, the elemental Ti and Ta powders are blended to at least a 20 wt %-80 wt % composition. In some embodiments, the step of hot-isostatically pressing is carried out at about 1073K and 180 MPa. It also can be noted that any other method to achieve solid blank of mixture metal powders can be used, such as sintering, mechanical pressing, cold isostatic pressing etc. In some embodiments, the atomized spherical Ti—Ta alloy powder comprises at least Ti-50 wt % Ta. In some embodiments, the Ti-50 wt % Ta atomized spherical Ti—Ta alloy powder comprises spherical β-Ti/Ta alloy particles. In some embodiments, the spherical β-Ti/Ta alloy particles include cubic tantalum or β-Ti alloy.

In yet another exemplary embodiment, a true spherical Ti-50 wt % Ta alloy powder is disclosed. The true spherical Ti-50 wt % Ta alloy powder is obtained by the process comprising the steps of: a) blending elemental Ti and Ta powders to form a 50 wt %-50 wt % Ti—Ta powder composition; b) hot-isostatically pressing the powder composition to form a Ti—Ta electrode; and c) processing the Ti—Ta electrode by electrode induction melting gas atomization (EIGA) to produce an atomized spherical Ti-50 wt % Ta powder comprising spherical β-Ti/Ta alloy particles. In some embodiments, the spherical β-Ti/Ta alloy particles include cubic tantalum or β-Ti alloy.

In yet another exemplary embodiment, a method of making a β-Ti alloy spherical powder for additive manufacturing is disclosed. The method comprises the steps of: a) blending elemental Ti and elemental X powder to form a Ti—X powder composition; b) hot-isostatically pressing the powder composition to form a Ti—X electrode; and c) processing the Ti—X electrode by electrode induction melting gas atomization (EIGA) to produce an atomized spherical Ti-50 wt %X alloy powder, wherein the Ti-50 wt % X powder comprises spherical β-Ti alloy particles. In some embodiments, X is selected from Mo, Nb, Zr, Hf, W, or a combination thereof.

### BRIEF DESCRIPTION OF THE DRAWINGS

FIG. 1 is a Ta—Ti phase diagram in accordance with the present invention;

FIG. 2 is an XRD of the atomization process involving melting of the tip of the EIGA in accordance with one embodiment of the present invention;

FIG. 3 is a metallography of the melted electrode tip area in accordance with one embodiment of the present invention;

FIG. 4 depicts the particle size distribution of Ti-50% Ta atomized powder unscreened in accordance with one embodiment of the present invention;

FIG. 5 depicts an SEM image of atomized unscreened Ti-50% Ta powder in accordance with one embodiment of the present invention;

FIG. 6 depicts a polished (left) and etched in HF: HNO₃ particle of Ti-50% Ta in accordance with one embodiment of the present invention;

FIG. 7 depicts an SEM image (upper left) and EDS images of Ti—Ta particle in accordance with one embodiment of the present invention;

FIG. 8 is an XRD of atomized Ti—Ta powder in accordance with one embodiment of the present invention; and

FIG. 9 depicts β-Ti and Ta lattice parameters in accordance with one embodiment of the present invention.

### DESCRIPTION OF THE INVENTION

The present invention generally relates to β-Ti or Ta alloy spherical powders obtained by electrode induction melting gas atomization (EIGA) that are suitable for additive manufacturing, and methods of making the same. The invention generally discloses a β-Ti or Ta alloy spherical powder that can be used in additive manufacturing processes, and that be specifically used for the additive manufacturing of biomedical applications.

The present invention provides for a method of making an atomized spherical β-Ti/Ta alloy powder for additive manufacturing. The method first comprises blending elemental Ti and Ta powders to form a Ti—Ta powder composition. The Ti—Ta powder composition comprises elemental Ti and Ta powders that are at least 99.99% pure. In some embodiments, the Ti and Ta powders were blended to about a 50 wt %-50 wt % composition.

In a second step, the method provides for hot-isostatically pressing the powder composition to form a Ti—Ta electrode. In some embodiments, the Ti—Ta electrode is in the form of an ingot. In some embodiments, the 50 wt %-50 wt % composition is hot-isostatically pressed (HIP) into 2″ round ingots at approximately 1073K and 180 MPa for about 2 hours. The Ti—Ta electrodes or ingots are subsequently prepared for use in an EIGA atomizer. A person of ordinary skill in the art would readily understand the conventional techniques to prepare an ingot or electrode for EIGA.

Electrode induction melting gas atomization (EIGA) is a common and well established method for producing desired spherical particles. Under vacuum or inert gas protection, a feedstock rod (in the form of raw materials) is heated by a high frequency induction coil and melted inductively and continuously in the absence of crucible. The molten falls free and flows into an atomization system and is crushed into a large number of small liquid droplets by high pressure inert gas from an atomizer spray plate. The small liquid droplets are then solidified into spherical granular powders in flight. The spherical particles or powders that result from EIGA include a wide range of particle size distribution in the range of between 0-500 μm.

The method of the present invention utilizes EIGA atomizer due to its high temperature capability (i.e. capability to process alloys with a melting point close to 2,773K), and the absence of crucible and ceramic nozzle, thus preventing any ceramic inclusions contamination in the alloy powders. In some embodiments, by utilizing the EIGA process, electron beam (EB) or arc-melting (AM) to first prepare the alloy prior to EIGA can be avoided.

In a third step, the Ti—Ta electrode or ingot is processed by electrode induction melting gas atomization (EIGA) to produce an atomized spherical Ti—Ta alloy powder. The atomized spherical Ti—Ta alloy powder of the present invention can be utilized in the additive manufacturing or 3D-printing process.

In some embodiments, the atomized spherical Ti—Ta alloy powder comprises at least Ti-50 wt % Ta. The atomized spherical Ti-50 wt % Ta powder is obtained by EIGA atomization of a blended elemental Ti—Ta compact, wherein this powder has β-Ti or Ta structure and can be used for additive manufacturing process. In some embodiments, the method of the present invention can also be applied to the development of new powders of high melting point alloys in the Ti—Ta system and can be also used for other combinations of metal couples. In some embodiments, the present method is suitable for the production of other Ti alloys with Mo, Nb, Zr, Hf, W, or a combination thereof.

In some embodiments, the Ti-50 wt % Ta atomized spherical Ti—Ta alloy powder comprises spherical β-Ti/Ta alloy particles. In some embodiments, the spherical β-Ti/Ta alloy particles of the present invention include cubic tantalum or β-Ti alloy.

The present invention further provides for a true spherical Ti-50 wt % Ta alloy powder. As one skilled in the art would understand, “true” spherical powders are known to have lower surface oxidation than irregular, with a globular shape and aspect ratio close to one (i.e. aspect ratio=width/length).

The true spherical Ti-50 wt % Ta alloy powder is obtained by the process comprising the steps of: a) blending elemental Ti and Ta powders to form a 50 wt %-50 wt % Ti—Ta powder composition; b) hot-isostatically pressing the powder composition to form a Ti—Ta electrode; and c) processing the Ti—Ta electrode by electrode induction melting gas atomization (EIGA) to produce an atomized spherical Ti-50 wt % Ta powder comprising spherical β-Ti/Ta alloy particles. In some embodiments, the spherical β-Ti/Ta alloy particles include cubic tantalum or β-Ti alloy.

The present invention further provides for a method of making a β-Ti alloy spherical powder for additive manufacturing. The method comprises the steps of: a) blending elemental Ti and elemental X powder to form a Ti—X powder composition; b) hot-isostatically pressing the powder composition to form a Ti—X electrode; and c) processing the Ti—X electrode by electrode induction melting gas atomization (EIGA) to produce an atomized spherical Ti-50 wt % X alloy powder, wherein the Ti-50 wt % X powder comprises spherical β-Ti alloy particles. In some embodiments, X is selected from Mo, Nb, Zr, Hf, W, or a combination thereof.

In the foregoing specification, the invention has been described with reference to specific embodiments thereof. It will be evident that various modifications and changes can be made to the methods and targets of the invention without departing from the broader spirit or scope of the invention as set forth in the appended claims. Accordingly, the specification is to be regarded in an illustrative rather than a restrictive sense.

### Experimental

Titanium powder (atomized 99.99% pure, made by Tosoh) and Ta powder (99.95% pure, Ulba) were blended to 50 wt %-50 wt % composition and then hot isostatically pressed (HIP) into 2″ round ingots at 1073K and 180 MPa for 2 hours in a steel container. The Ti-50% Ta ingots were then prepared to use in EIGA atomizer by removing steel can. Spherical Ti-50% Ta powder was obtained by EIGA (electrode induction-melting gas atomization) of Ti-50% Ta rods using Argon gas (Praxair) for atomization on tailor-made equipment. The raw powder was fractionized by sieving (<45 μm, <150 μm). SEM (Hitachi S-3600) with EDAX (Z4 Analyzer) was used to study the alloy particles. X-ray diffraction studies of the powders (Rigaku SmartLab X-Ray Diffractometer; Cu Kα radiation, 2Θ=10−80°. The powders were characterized by means of chemical analysis, XRD, SEM, EDX and particle size distribution.

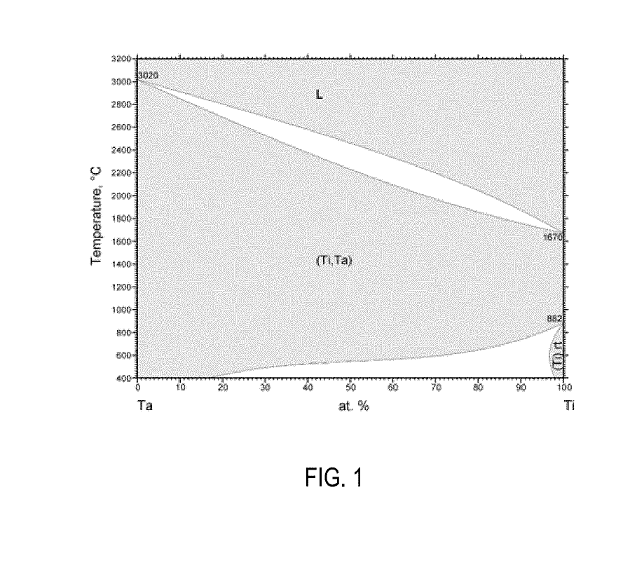

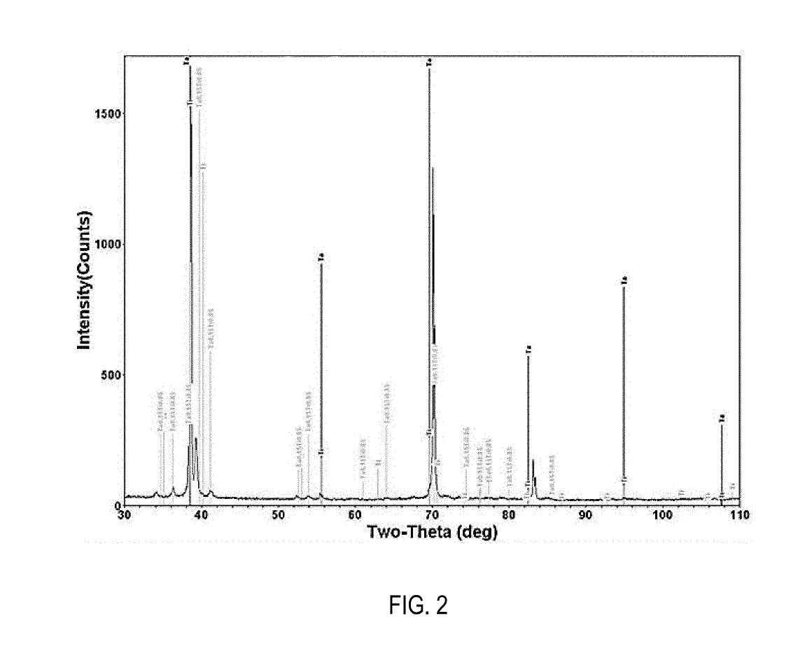

As shown by the phase diagram in FIG. 1, Ti-50 wt % Ta composition, melting point for this alloy should be about 2273K. This melting point should make it difficult or impossible to atomize in conventional atomization equipment and requires either arc or electron beam melting.

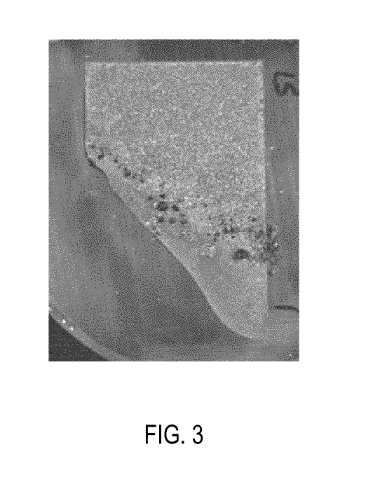

Hot isostatically pressed (HIP) blended elemental Ti and Ta powders were used. While the internal body of the electrode is a clear blend of Ti and Ta (XRD demonstrated this and not shown), which did not interdiffuse and form any alloy during HIP process, the tip of electrode was subjected to local melting. The atomization process was interrupted and the phase composition of the tip was analyzed, which appears rather complex. The XRD represents a significant pattern shift with no clear matches to any phase, as shown in FIG. 3. Ta, α-Ti, β-Ti and Ta_{0.15}T_{0.85} phases were used for possible phase matching. As the tip cooled down from about 2300K to room temperature (about 10-15 min.), where it can be assumed that some quenching happened to this area.

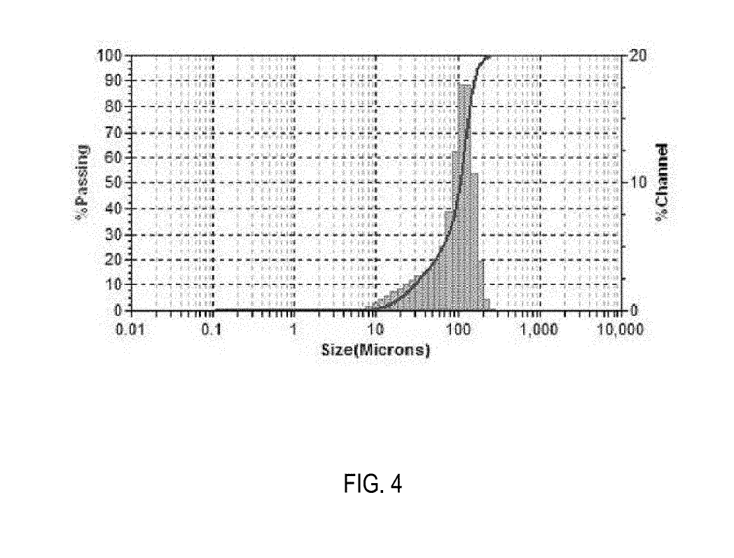

As shown in FIG. 4, atomized powder as produced has theoretical density of Ti-50 wt % Ta is 7.08 g/cm³. Therefore, measuring particle size distribution may result in apparent bimodality decreasing with increasing of water flow. As such, water flow was increased to 90% in order to avoid bimodal distribution results.

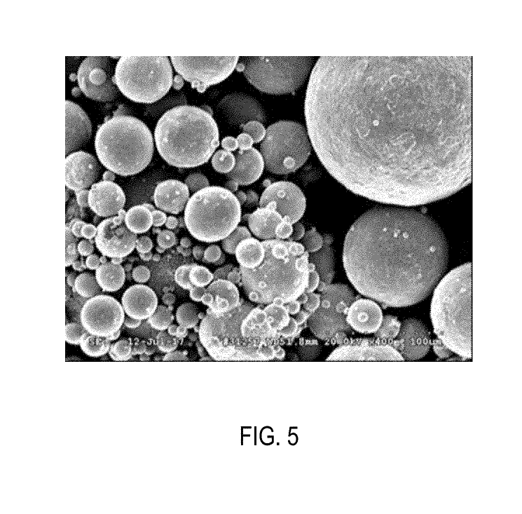

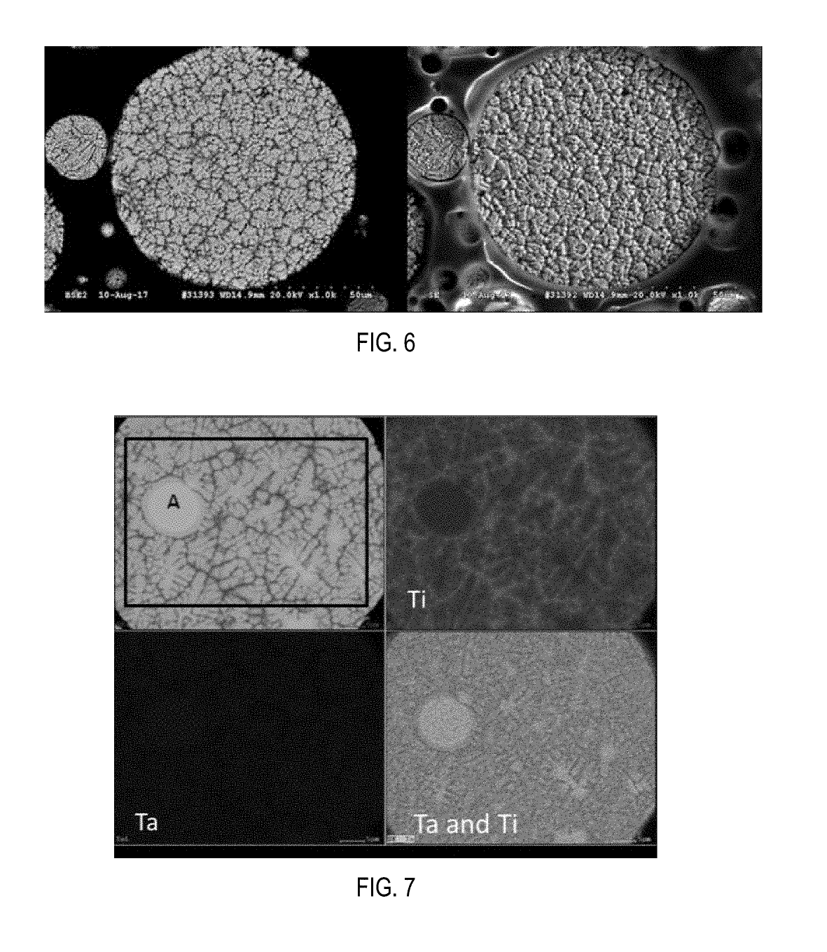

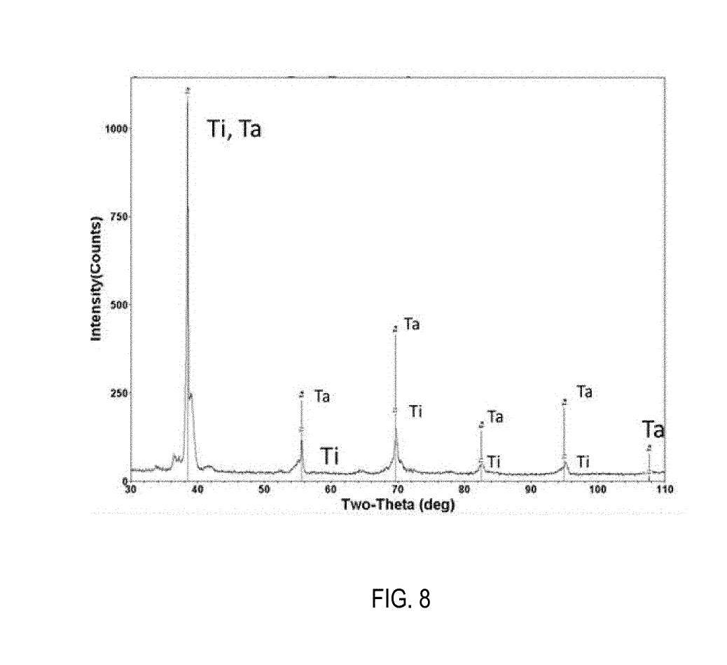

As shown in FIG. 5, the SEM image of atomized unscreened Ti-50% Ta powder is shown, and all particles are spherical. This signifies that no original tantalum particles have fallen through without melting. However, internal particle microstructure is complex and can be described as multicompositional β-Ti alloy. This can be demonstrated on metallographically polished and etched powder sample (1:1 mixture of HNO₃ and HF). The resulted images are shown in FIG.6. EDS analysis of the large area shows composition ratio close to 50% (56 wt % Ti).

More detailed study of particles microstructure reveals that some area can be Ta rich but always contain both Ta and Ti which proves that complete melting had happened. This is shown in FIG. 7 where Ta rich zones are visible. As shown in FIG. 7, area A included 61 wt % Ta and the rectangle area included 47 wt % Ta. This is not un-melted Ta particle, but rather tantalum rich area. While there is a Ta rich area, the powder XRD analysis shows that the atomized powder can be interpreted as cubic tantalum or β-Ti alloy.

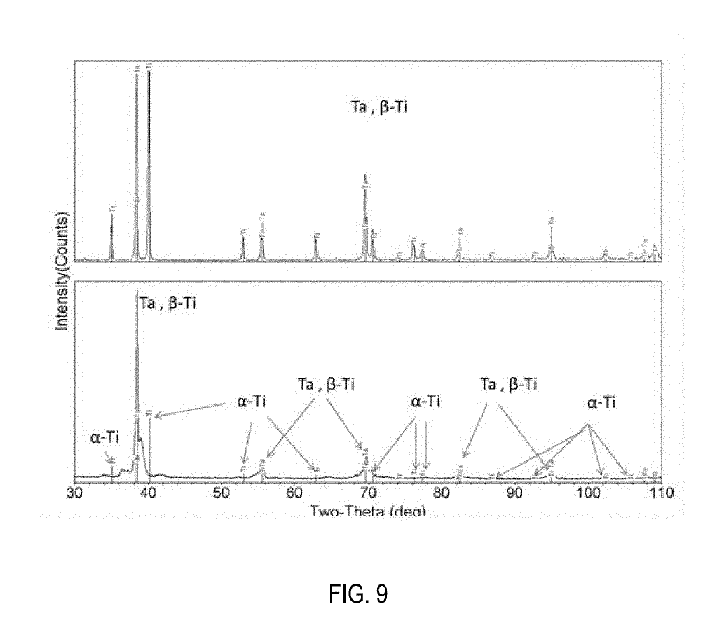

As shown in FIG. 9, the β-Ti and Ta lattice parameters are remarkably similar (3.3065 and 3.3058, respectively). These results are not consistent with results previously obtained that showed that phase composition of the alloys varies with the Ta content in the alloy, and at 29 wt % Ta and above, it is the orthorhombic martensite (α″) forms and fully β-phase alloys are only obtained for Ta contents of 76 wt % and above. Also, no Acicular martensite (α′) was observed.

1. A method of making an atomized spherical β-Ti/Ta alloy powder for additive manufacturing, the method comprising the steps of:
a) blending elemental Ti and Ta powders to form a Ti—Ta powder composition;
b) hot-isostatically pressing said powder composition to form a Ti—Ta electrode; and
c) processing said Ti—Ta electrode by electrode induction melting gas atomization (EIGA) to produce an atomized spherical Ti—Ta alloy powder.

2. The method as in claim 1, wherein said elemental Ti and Ta powders are blended to at least a 50 wt %-50 wt % composition.

3. The method as in claim 1, wherein said elemental Ti and Ta powders are blended to at least a 20 wt %-80 wt % composition.

4. The method as in claim 1, wherein said step of hot-isostatically pressing is carried out at about 1073K and 180 MPa.

5. The method as in claim 1, wherein said atomized spherical Ti—Ta alloy powder comprises at least Ti-50 wt % Ta.

6. The method as in claim 5, wherein said Ti-50 wt % Ta atomized spherical Ti—Ta alloy powder comprises spherical β-Ti/Ta alloy particles.

7. The method as in claim 6, wherein said spherical β-Ti/Ta alloy particles include cubic tantalum or β-Ti alloy.

8. A true spherical Ti-50 wt % Ta alloy powder, the product obtained by the process comprising the steps of:
a) blending elemental Ti and Ta powders to form a 50 wt %-50 wt % Ti—Ta powder composition;
b) hot-isostatically pressing said powder composition to form a Ti—Ta electrode; and
c) processing said Ti—Ta electrode by electrode induction melting gas atomization (EIGA) to produce an atomized spherical Ti-50 wt % Ta powder comprising spherical β-Ti/Ta alloy particles.

9. The method as in claim 8, wherein said spherical β-Ti/Ta alloy particles include cubic tantalum or ρ-Ti alloy.

10. A method of making a β-Ti alloy spherical powder for additive manufacturing, the method comprising the steps of:
a) blending elemental Ti and elemental X powder to form a Ti—X powder composition;
b) hot-isostatically pressing said powder composition to form a Ti—X electrode; and
c) processing said Ti—X electrode by electrode induction melting gas atomization (EIGA) to produce an atomized spherical Ti-50 wt %X alloy powder,
wherein said Ti-50 wt %X powder comprises spherical β-Ti alloy particles.

11. The method as in claim 10, wherein said X is selected from Mo, Nb, Zr, Hf, W, or a combination thereof.
